(19) United States
(12) Patent Application Publication
(10) Pub. No.: US 2003/0049017 A1
(43) Pub. Date: Mar. 13, 2003

(54) Information storage medium containing preload information, apparatus for and method of reproducing therefor

(75) Inventors: Hyun-kwon Chung, Gyeonggi-do (KR); Jung-wan Ko, Gyeonggi-do (KR); Jung-kwon Heo, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd.

(21) Appl. No.: 10/170,419

(22) Filed: Jun. 14, 2002

(30) Foreign Application Priority Data
Jun. 14, 2001 (KR) 2001-33526
Sep. 27, 2001 (KR) 2001-60137
Oct. 23, 2001 (KR) 2001-65393

(51) Int. Cl. H04N 5/781

(52) U.S. Cl. 386/95; 386/125

(57) ABSTRACT

An information storage medium which contains preload information, a reproducing apparatus and a reproducing method. The information storage medium includes AV data and a markup language document displaying the AV data which is decoded and reproduced and including preload information that allows the reproducing apparatus to read a file to be preloaded and to store it into a memory. The information storage medium contains the markup language document to prevent a video picture from being interrupted when the AV data recorded in the DVD is reproduced and displayed through the markup language document. The reproducing apparatus and reproducing method reproduce information from the information storage medium.

### CROSS REFERENCE TO RELATED APPLICATIONS

This application claims the benefit of Korean Patent Application Nos. 2001-33526, 2001-60137, 2001-65393, filed Jun. 14, 2001, Sep. 27, 2001, Oct. 23, 2001, respectively, in the Korean Industrial Property Office, the disclosures of which are incorporated herein by reference.

### BACKGROUND OF THE INVENTION

1. Field of the Invention

The present invention relates to an information storage medium which contains preload information, a reproducing apparatus and a reproducing method, and more particularly, to an information storage medium which contains AV data and multiple markup language documents that are displayed by a markup document viewer, and an apparatus for and a method of reproducing the information storage medium.

2. Description of the Related Art

An interactive DVD (Digital Versatile Disc) medium may be reproduced by a personal computer (PC) in an interactive mode. The interactive DVD medium contains markup language document data and AV data. A content corresponding to the data stored in the interactive DVD medium can be reproduced in two ways, that is, in a video mode or the interactive mode. In the video mode, the content is displayed in the same way that a disc playback on a regular DVD player is displayed, whereas in the interactive mode, the content is displayed in a display window defined by a markup language document. If the interactive mode is selected by a user, a web browser built in the personal computer (PC) displays the markup language document recorded in the interactive DVD medium and the content selected by the user in the display window defined by the markup language document.

For example, in the interactive mode, a video picture of the movie corresponding to the AV data is displayed in a portion of the display window defined by the markup language document, and in the remaining portion of the display window, a variety of supplementary information including scripts, stories, photos of actors and actresses, etc., can be displayed. The supplementary information can include an image file or a text file.

FIG. 1 is an outline diagram of an interactive DVD medium where AV data is recorded. With reference to FIG. 1, on tracks of the interactive DVD medium, the AV data is recorded as a form of an MPEG bit stream, and multiple markup language document data is also recorded. A markup language document can mean a web resource including various graphic image files inserted into the markup language document.

FIGS. 2A and 2B are reference diagrams showing an interruption that may occur while a reproducing apparatus reproduces the interactive DVD medium of FIG. 1.

FIG. 2A shows a data occupancy of a buffer memory that buffers the AV data, and FIG. 2B shows a data occupancy of a cache memory that caches the web resources. With regard to FIGS. 1, 2A and 2B, during loading of the AV data to the memory and displaying of the AV data, a pick-up device seeks and reads a file STARTUP.HTM and loads it into the cache memory.

When the loaded file STARTUP.HTM is activated, the AV data (1) selected by an AV data presentation sequence is loaded into the buffer memory and starts to be displayed. Then, the AV data (2) is loaded and displayed. After the AV data (2) is completely buffered, the pick-up device of the reproducing apparatus jumps to a position where the AV data (3) is recorded and starts to buffer the AV data (3). If the user requests a file A.HTM (4), the pick-up device stops buffering the AV data (3) and seeks the file A.HTM (4) and reads it to the cache memory. Meanwhile, since the AV data (3) continues to be displayed, the amount of the AV data to be loaded is consumed drastically while the file A.HTM (4) is activated.

After the AV data (3) is completely buffered, the pick-up device buffers the AV data (5). If the AV data (5) is completely buffered, the pick-up device jumps to another position where the AV data (6) is recorded. In that case, exhaustion of the buffered data may happen. That is, in a case of a currently existing interactive DVD, if the video picture of the movie and the markup language documents need to be displayed synchronously (for example, when an actor is on stage, his brief history is displayed together with his video picture), the pick-up device should stop buffering the AV data and seek and cache the related markup language documents. Therefore, the reproducing of the video picture may be temporarily interrupted.

### SUMMARY OF THE INVENTION

To solve the above and other problems, it is an object of the present invention to provide an information storage medium that enables contents stored in the information storage medium to be reproduced seamlessly in a display window defined by a markup language document, and an apparatus for and a method of reproducing information from the information storage medium.

It is another object of the present invention to provide an information storage medium containing a markup language document that needs to be reproduced in synchronization with a content stored in the information storage medium and that is loaded to/discarded from a cache memory so that the content can be reproduced seamlessly in a display window defined by a markup language document, and an apparatus for and a method of reproducing the information storage medium.

It is still another object of the present invention to provide an information storage medium that allows a file to be more efficiently preloaded by providing information on a type of a file to be preloaded so that each content of the file can be reproduced seamlessly in a display window defined by a markup language document, and an apparatus for and a method of reproducing the information storage medium.

It is yet another object of the present invention to provide a method of guaranteeing that sufficient data remains in a memory even though a preloading function is performed during reproducing a content stored in the memory.

It is still yet another object of the present invention to provide a method of managing a memory so that a preloading and discarding function of a file to be displayed can be performed in a strict predetermined manner.

Additional objects and advantageous of the invention will be set forth in part in the description which follows and, in part, will be obvious from the description, or may be learned by practice of the invention.

To achieve the above and other objects, an information storage medium includes audio/video (AV) data, and markup language document data including preload information that allows a reproducing apparatus to read files to be preloaded and to store them into a memory to display the AV data which is decoded and reproduced.

According to an aspect to the present invention, the information storage medium further includes reproducing control information on the AV data, and the AV data is decoded in an AV data stream with reference to the reproducing control information.

According to another aspect to the present invention, the information storage medium further includes a preload list file which includes the files to be preloaded, and at least one of the files to be preloaded.

According to another aspect to the present invention, the preload information is implemented by a link tag where location information of the preload list file is recorded, or an Application Program Interface (API) which has the location information of the preload list file as a parameter. The preload list file includes the location information and a type of the files to be preloaded.

To achieve the above and other objects, an information storage medium comprises AV data and markup language document data including a markup language document and a preload information that allows a reproducing apparatus to read files to be preloaded and to store them into a memory to display the AV data which is decoded and reproduced in an AV data stream.

It is possible that the preload information is implemented by an API which has location information of the preload list file as a parameter. It is possible that the location information includes a path of the preload list file and a resource locator, which indicates one of the memory, the information storage medium, and an Internet server, which is linked to the reproducing apparatus in accordance with the path of the preload list file.

It is possible that the markup language document includes discard list files which contain a discard files list and discard information which indicates that files, which are recorded in the discard list file should be discarded from the memory.

To achieve the above and other objects, provided is a method of reproducing AV data recorded in an information storage medium by invoking the AV data through a markup language document. The method includes interpreting preload information included in the read markup language document, retrieving files to be preloaded based on the preload information and storing the files to a cache memory, reading the AV data and storing it in a buffer memory, and reproducing the AV data and the files to be preloaded from the buffer memory and the cache memory, respectively, and displaying them based on the markup language document.

It is possible that the interpreting of the preload information includes identifying a path and a type of the file to be preloaded, and identifying the path of a preload list file that is recorded in a link tag inserted in a region bounded by a head tag.

It is possible that the retrieving of the files includes reading the file to be preloaded from the identified path, and processing and storing the file to be preloaded depending on the identified type.

To achieve the above and other objects, provided is an apparatus for reproducing AV data recorded in an information storage medium with markup language document data corresponding to markup language documents. The apparatus includes a reader reading markup language documents or the AV data, a memory storing files to be preloaded or the AV data, an AV decoder decoding the AV data stored in the memory, and a presentation engine requesting that the files to be preloaded be stored in the memory based on the interpreted preload information after interpreting a preload information included in the read markup language document, requesting that the read AV data to be stored in the memory, and retrieving the files to be preloaded from the memory and displaying the file together with the AV data outputted by the AV decoder.

It is possible that the memory includes a buffer memory storing the AV data and a cache memory storing the files to be preloaded.

It is possible that the presentation engine identifies the path and the type of the file to be preloaded based on the preload information, retrieves the files to be preloaded from the identified path, and stores the files according to the type of the files in the cache memory.

It is possible that the presentation engine requests the reader to read the file to be preloaded or an Internet server to send the file to be preloaded, compares vacancy amount (size) of a space remaining in the cache memory with a data amount (size) of the files to be preloaded and generates an error signal if the vacancy amount of the space remaining in the cache memory is less than the data amount (size) of the files to be preloaded, and refers the cache memory to read the files to be preloaded if the resource locator relating to the path of the preload list file indicates the cache memory, or generates an error signal if there is no file to be referred to in the cache memory.

To achieve the above and other objects, provided is a method of performing a preloading function. The method includes identifying the speed at which a file to be preloaded is read, identifying a condition that a buffering function is performed in such a way that relevant AV data can be reproduced seamlessly, and performing the preloading function at the time identified to be an optimized condition.

A method of recording preload information in an information storage medium comprises generating a list of files to be preloaded, identifying a speed at which the recorded files to be preloaded are read, identifying a condition that a buffering function is performed in such a way that relevant AV data can be reproduced seamlessly, and recording script program codes to perform the preloading function at a time which is identified to be an optimized condition of a memory.

A method of managing a memory to perform a preloading function includes creating and modifying memory management table information containing status information of files to be preloaded, and discarding the file to be preloaded based on the status information.

It is possible that the method of managing the memory to perform a preloading function further includes performing a garbage collection on the files to be preloaded based on the status information.

It is possible that the discarding of the file is performed when the cached file is in a “not in use” or discarded status. It means that the files to be preloaded are not used for the preloading function any more and may be discarded.

It is possible that the performing of the garbage collection includes discarding the preloaded files from the cache memory physically if it is not in use and is to be discarded, indicating that the files to be preloaded no longer exist in the cache memory, and realigning the files to remain in the cache memory.

### BRIEF DESCRIPTION OF THE DRAWINGS

These and other objects and advantageous of the invention will become apparent and more readily appreciated from the following description of the preferred embodiments, taken in conjunction with the accompanying drawings of which:

FIG. 1 is a diagram of an interactive DVD medium;

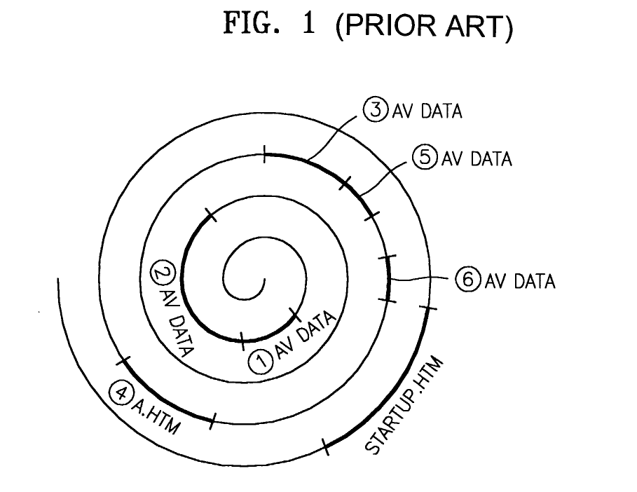

FIGS. 2A and 2B are reference diagrams showing an interruption that may occur during reproducing the interactive DVD medium of FIG. 1;

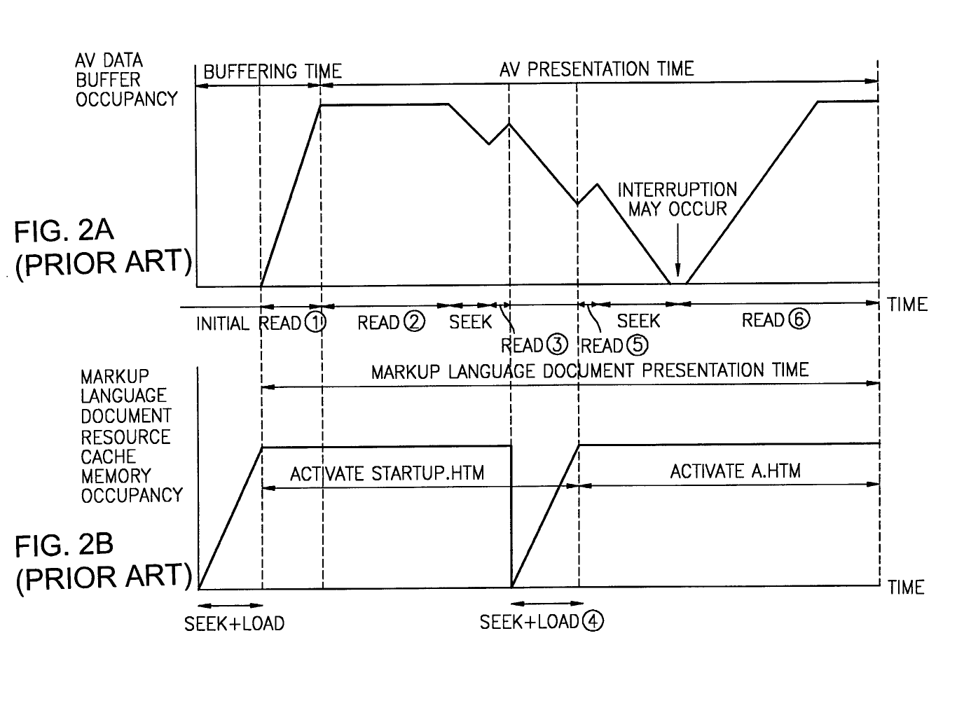

FIG. 3 is a block diagram of a reproducing apparatus according to an embodiment of the present invention;

FIG. 4A is a diagram showing a directory structure of files in a DVD of FIG. 3;

FIG. 4B is a diagram showing another directory structure of the files in the DVD of FIG. 3;

FIG. 5A is a diagram showing a volume space of the DVD of FIG. 3;

FIG. 5B is a diagram showing another volume space of the DVD of FIG. 3;

FIG. 6 is a flowchart explaining a reproducing method according to another embodiment of the present invention;

FIG. 7 is a detailed flow chart showing the interpreting of the preload information of operation 602 of FIG. 6;

FIG. 8 is a detailed flow chart showing the storing of the files in operation 603 of FIG. 6, where the files to be preloaded are preloaded;

FIG. 9A is another detailed flow chart of operation 603 of FIG. 6;

FIG. 9B is yet another detailed flow chart of operation 603 of FIG. 6;

FIG. 10 is a flowchart explaining a method of preloading the files to be preloaded when a preload list file includes the data amount or size of the file to be preloaded;

FIG. 11 is a flowchart explaining a method discarding at least one of the files to be preloaded that are stored in the memory;

FIG. 12 is a detailed flow chart showing a discarding function of operation 1102 of FIG. 11;

FIGS. 13A and 13B are reference diagrams explaining an effect of a preloading function performed when the AV data and markup language documents are recorded in the same order as shown in FIG. 1;

FIG. 14 is a detailed diagram of a part of the reproducing apparatus of FIG. 3;

FIGS. 15 and 16A through 16F are memory maps explaining a method of managing memory management table information and data by performing the preloading, discarding and garbage collection functions;

FIG. 17 is a reference diagram showing a case where the AV data is loaded into and exhausted in a first memory of the reproducing apparatus of FIG. 3;

FIG. 18 is a diagram showing a data alignment of the preload list file and the files to be preloaded on the information storage medium;

FIGS. 19A and 19B are an outline diagram of a disc and a detailed diagram of a part of the disc of FIG. 19A;

FIGS. 20A and 20B are reference diagrams showing a status of a first memory and a second memory of FIG. 3; and

FIG. 21 is a flowchart showing a recording method according to another embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

The present invention now will be described more fully with reference to the accompanying drawings, in which preferred embodiments of the invention are shown. The markup language document defined in the specification means not only a markup language document itself but also web resources inserted into or linked with a hypertext markup language (HTML) document. HTM means not only the HTML itself but also the documents described in a mark-up language, such as a multiple markup language (XML) and a standard generated markup language (SGML), which can be displayed via a markup document viewer.

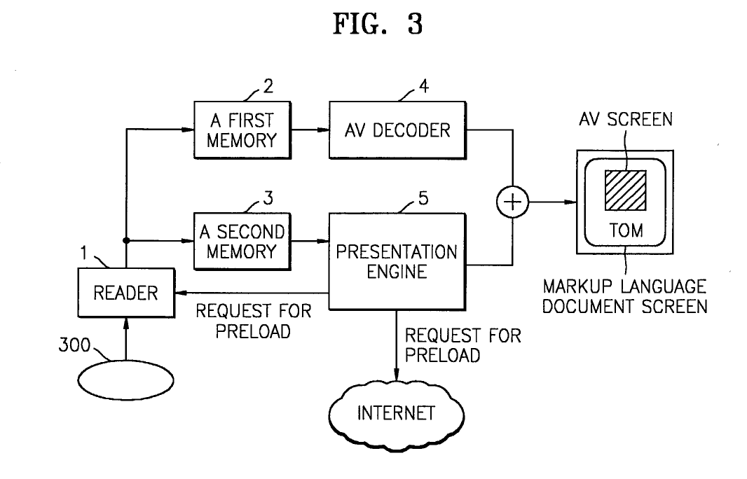

FIG. 3 is a block diagram of a reproducing apparatus according to an embodiment of the present invention.

With reference to FIG. 3, the reproducing apparatus decodes audio/video (AV) data recorded in a DVD 300 and reproduces the AV data as an AV data stream. Then, the reproducing apparatus displays a video picture corresponding to the AV data in a display window defined by a markup language document in an interactive mode and includes a reader 1, a first memory 2, a second memory 3, an AV decoder 4, and a presentation engine 5. As described later, the presentation engine 5 supports an extension of a link tag, JavaScript, and Java applet so that preload information and discard information which are implemented by the link tag, a JavaScript Application Program Interface (API), or a Java applet API, can be interpreted and executed.

The reader 1 reads the markup language document file or the AV data from the DVD 300. The first memory 2 is a buffer memory that buffers the AV data read by the reader 1. The second memory 3 is a cache memory that caches the retrieved markup language document file. The AV decoder 4 decodes the AV data stored in the first memory 2 and outputs the AV data stream. The presentation engine 5 interprets the preload information included in the markup language document data, and requests the reader 1 to read the files to be preloaded or an Internet server (not shown) to send the files to be preloaded so that the files can be preloaded into the second memory 3 based on the interpreted preload information. When the files to be preloaded need to be displayed together with the AV data simultaneously, the presentation engine 5 invokes the file to be preloaded from the second memory 3 and displays the read file together with the AV data stream outputted by the AV decoder 4. In addition, the presentation engine 5 interprets the discard information and discards the files to be discarded from the second memory 3.

The DVD 300 includes not only the AV data containing audio data or video data but also the markup language document data containing the preload information and the discard information. Furthermore, a preload list file and a discard list file may be recorded in the DVD 300.

The preload list file lists the names of the files to be preloaded and information about the data amount (size) of a memory necessary to store each file to be preloaded. The files to be preloaded is the markup language document which may need to be reproduced in synchronization with the relevant AV data and is recorded in the DVD 300. The files to be preloaded can be stored in the Internet server that can be accessed over the Internet.

The preload information instructs that the files to be preloaded are read and stored in the cache memory. For example, the preload information can be implemented as the link tag where a path and a type of the preload list file or the files to be preloaded are inserted. The link tag is inserted into a region bounded by a head tag of the markup language document data. In another example, the preload information can be implemented as the JavaScript API or the Java applet API which has the path and the type of the preload list file as parameters and invokes the preload list file. In a third example, the preload information can be implemented as the JavaScript API or the Java applet API which has the path and the type of the file to be preloaded as parameters and invokes the file to be preloaded without the preload list file.

The type of the files is information that provides the similar definition as a Multi-Purpose Internet Mail Extensions (MIME) header. That is, the file type information indicates a data property of the file to be preloaded. Understanding the data property helps to process the file more effectively. For example, if the type of the file is interpreted before a markup language document file is preloaded, the markup language document file can be processed without analyzing the type of the file. If a graphic image file is preloaded, the graphic image file can be processed to be stored as a form without storing unnecessary header information in the cache memory. As a result, the memory space can be utilized effectively, and the file can be reproduced at a faster speed. If an audio file is preloaded, the audio file can be re-sampled at a much higher rate and played and stored by the reproducing apparatus. If a font file is preloaded, only the necessary information for a font raster will be extracted and stored. That is, understanding the type of the file to be preloaded helps to perform a preloading function more effectively and flexibly.

The path of the files indicates a location where a relevant file is recorded. A resource locator can be attached to the path of the preload list file and the file to be preloaded. The markup language documents may be recorded in the DVD 300, cached in the second memory 3, or exist in the Internet server that can be accessed over the Internet. Therefore, the resource locator of the markup language documents is classified as a DVD resource locator indicating the DVD 300, a cache resource locator indicating the second memory 3, and an Internet resource locator indicating the Internet server. The resource locators can be indicated in order as follows.

disk0:// or dvd://

lid://

http://

Therefore, when the file A.HTM recorded in the DVD 300 is retrieved as the file to be preloaded, the path is indicated as disk0://DVD_ENAV/A.HTM. When the file A.HTM cached in the second memory 3 is invoked as the file to be preloaded, the path is indicated as lid://DVD_ENAV/A.HTM. When the file A.HTM stored in the Internet server is received as the file to be preloaded, the path is indicated as http://www.samsung.com/DVD_ENAV/A.HTM. If multiple DVD media loaders each having the DVD 300 are equipped in the reproducing apparatus, the resource locators of each DVD 300 can be indicated as disk0://(or dvd://), disk 1://, disk 2://, disk 3://.

Even though the resource locator is attached (linked) to the path indicating the location of the file to be preloaded, the presentation engine 5 generates an error signal and ends the preloading if there is no file to be preloaded in the location indicated by the resource locator. However, if a scheme used in the resource locator is an implicit scheme, the reproducing apparatus searches the markup language document according to this sequence. the second memory 3 is searched first. If the file to be preloaded does not exist in the second memory 3, the DVD 300 is searched next.

The discard list file lists the information (name and path of the file) on the location of the file to be discarded. The discard information instructs that the files to be discarded are discarded from the second memory 3. For example, the discard information can be implemented as the JavaScript API or the Java applet API which has location information of the discard list file as a parameter and discards the files included in the discard list file. In another example, the discard information can be implemented as the JavaScript API or the Java applet API which has the path and the type of the file to be discarded as parameters and discards the file to be discarded without the discard list file.

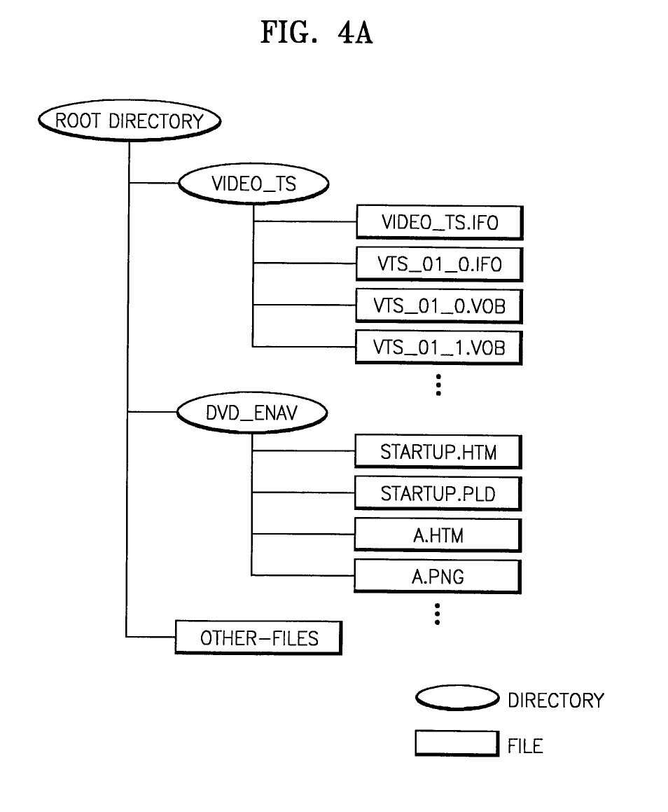

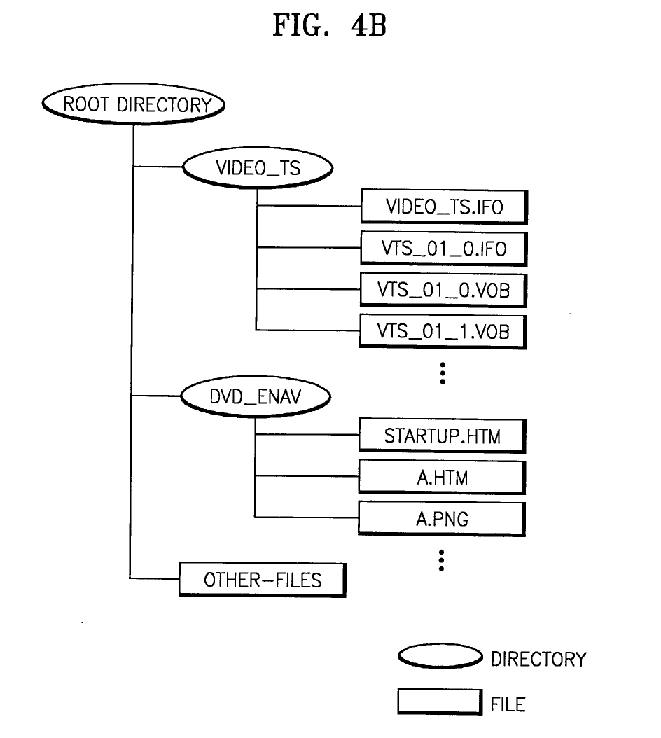

FIGS. 4A and 4B are diagrams showing a directory structure of files in the DVD 300.

With reference to FIG. 4A, a root directory includes subdirectories VIDEO_TS and DVD_ENAV. VIDEO_TS is a DVD video directory that includes the AV data. DVD_ENAV is a DVD interactive directory including the markup language document data that supports an interactive function.

The DVD video directory VIDEO_TS includes files VIDEO_TS.IFO, VTS_01_0.IFO, VTS_01_0.VOB and VTS_01_1.VOB.

In the file VIDEO_TS.IFO, first reproducing control information on the entire video title sets is recorded. In the file VTS_01_0.IFO, the first reproducing control information on the first video title set is recorded. In VTS_01_0.VOB and VTS_01_1.VOB., the AV data that makes up the video title sets are recorded. More detailed configuration information is included in the DVD-Video Standard called as DVD-Video for Read Only Memory Disc 1.0.

The DVD interactive directory DVD_ENAV includes files DVD_ENAV.IFO, STARTUP.HTM, STARTUP.PLD, A.HTM, A.PNG, other files to be preloaded, and various types of files that are inserted into the files to be preloaded and displayed. In the file DVD_ENAV.IFO, second reproducing control information on the entire interactive information is recorded. The file STARTUP.HTM is designated as a start document of the multiple markup language documents. The file STARTUP.PLD is the preload list file including the preloading information. The file A.HTM is the file to be preloaded. The file A.PNG is the graphic image file that is inserted into the file A.HTM and displayed with the file A.HTM. The directory DVD_ENAV can include other files to be preloaded and various types of files that are inserted into the files to be preloaded and displayed.

However, in FIG. 4B, if the preload information is included in the markup language document and implemented as the API which has the path and the type of the file to be preloaded as parameters, the file to be preloaded are retrieved without the preload list file.

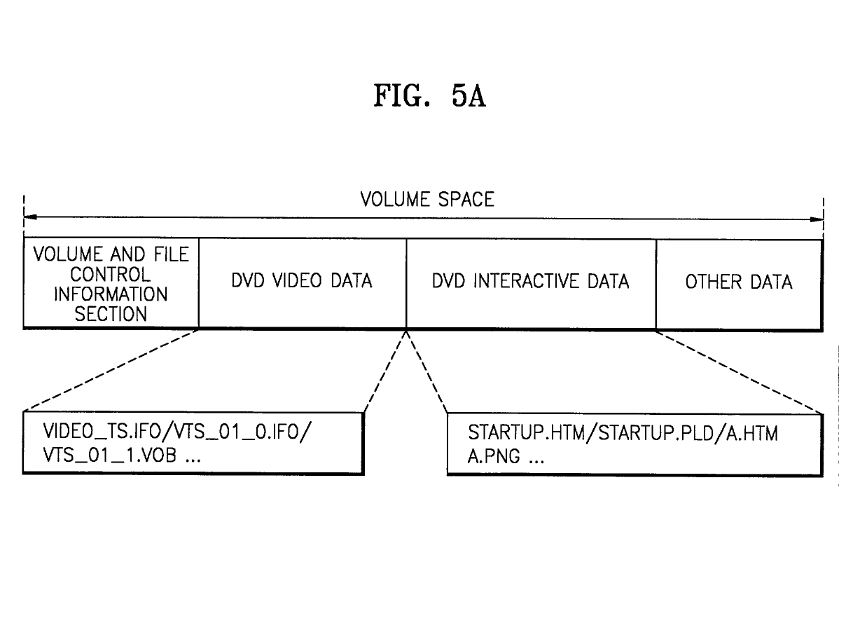

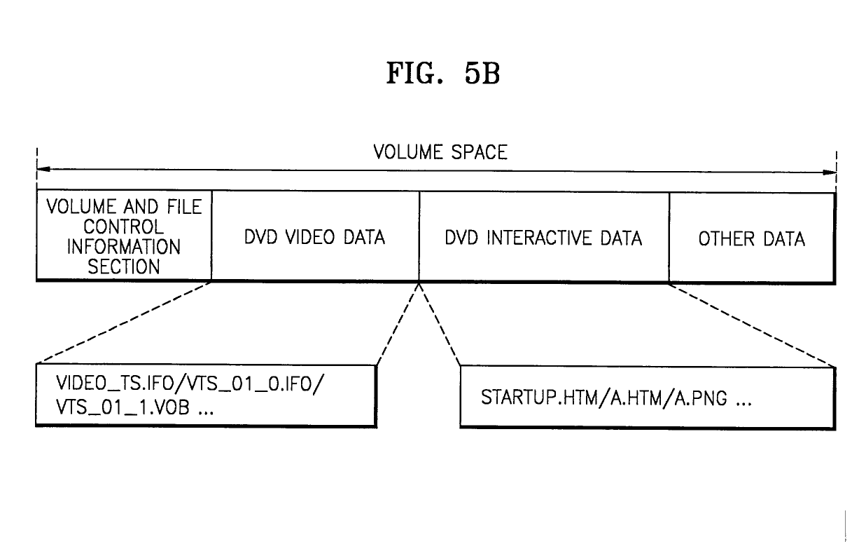

FIGS. 5A and 5 B are diagrams showing a volume space of the DVD 300.

With reference to FIG. 5A, the volume space of the DVD 300 includes a volume and file control information section, a DVD video data section containing a relevant video title data, and a DVD interactive data section which enables the reproducing apparatus to reproduce the DVD 300 in the interactive mode.

The DVD-video data section includes the files VIDEO_TS.IFO, VTS_01_0.IFO, VTS_01_0.VOB, VTS_01_1.VOB stored in the DVD video directory DVD_TS shown in FIG. 4A. The DVD interactive data section includes the files STARTUP.HTM, STARTUP.PLD, A.HTM, and A.PNG stored in the DVD interactive directory DVD_ENAV shown in FIG. 4A.

As described above, with reference to FIG. 5B, the preload information is included in the markup language document and implemented as the API which has the path and the type of the file to be preloaded as parameters and retrieves the file to be preloaded without the preload list file.

The interactive function of the reproducing apparatus is performed in the interactive mode as follows.

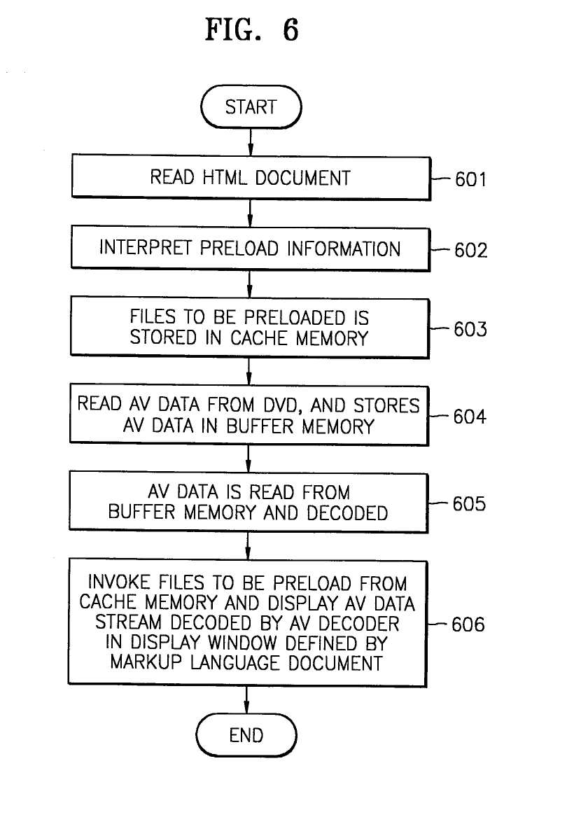

FIG. 6 is a flowchart explaining a reproduction method according to another embodiment of the present invention.

With reference to FIG. 6, if the interactive mode is selected, the reader 1 reads the HTML document recorded in the DVD 300 in operation 601. The presentation engine 5 interprets the preload information included in the HTML document and requests the reader 1 to read the file to be preloaded or the Internet server to send the file to be preloaded for performing the preloading function in operation 602. In operation 603, the files to be preloaded are stored in the second memory 3, which is the cache memory.

The reader 1 reads the relevant AV data from the DVD 300 and stores the read AV data in the first memory 2, which is the buffer memory, in operation 604. The AV decoder 4 decodes the AV data stored in the first memory 1 in operation 605. The presentation engine 5 invokes from the second memory 3 the files to be preloaded and displays the AV data stream decoded by the AV decoder 4 in the display window defined by the markup language document in operation 606.

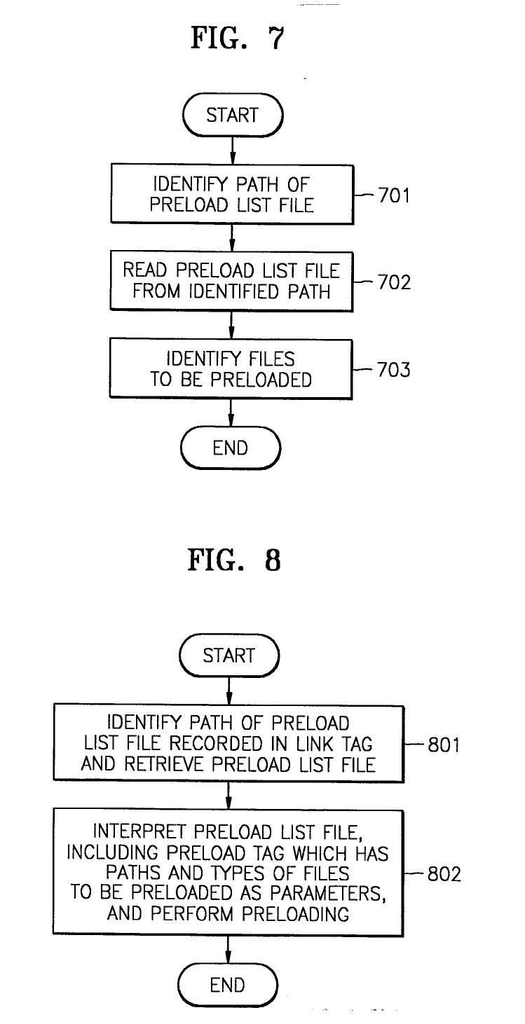

FIG. 7 is a detailed flow chart showing the interpreting of the preload information of operation 602 of FIG. 6.

With reference to FIG. 7, the presentation engine 5 identifies the path of the preload list file recorded in the markup language document in operation 701 and reads the preload list file from the identified path in operation 702. Then, the presentation engine 5 identifies the files to be preloaded in response to the preload file recorded in the the markup language document in operation 703. Here, the identifying of the files to be preloaded refers to identifying the path and the type of the files to be preloaded.

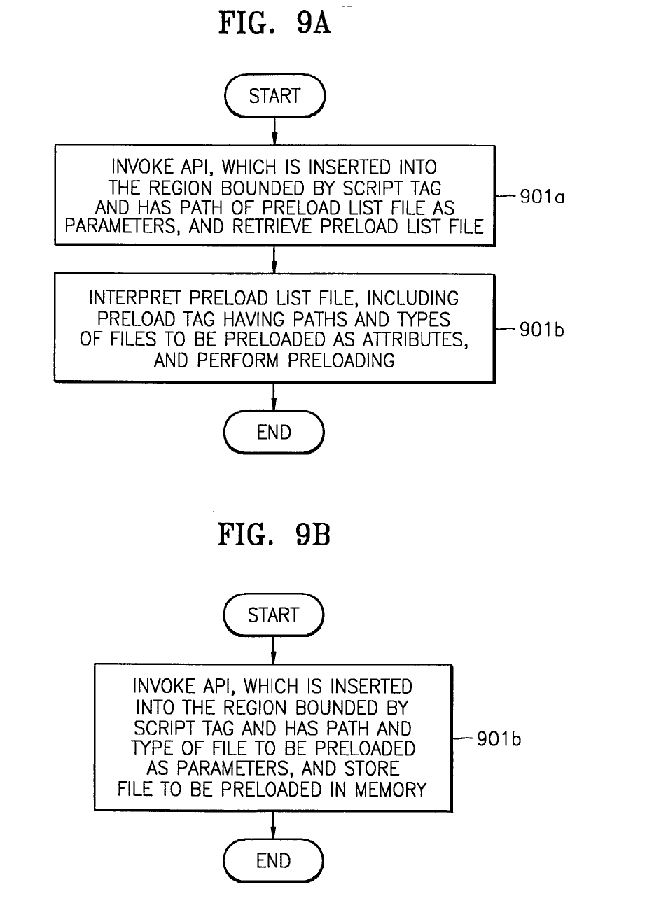

FIG. 8 is a detailed flow chart of operation 603 of FIG. 6, where the file to be preloaded is preloaded. Referring to FIG. 8, the presentation engine 5 identifies the path of the preload list file recorded in the link tag inserted in the region bounded by the head tag of the HTML document and retrieves the preload list file in operation 801. In operation 802, the presentation engine 5 interprets the preload list file, including a preload tag which has the path and the type of the file to be preloaded as parameters, and performs preloading.

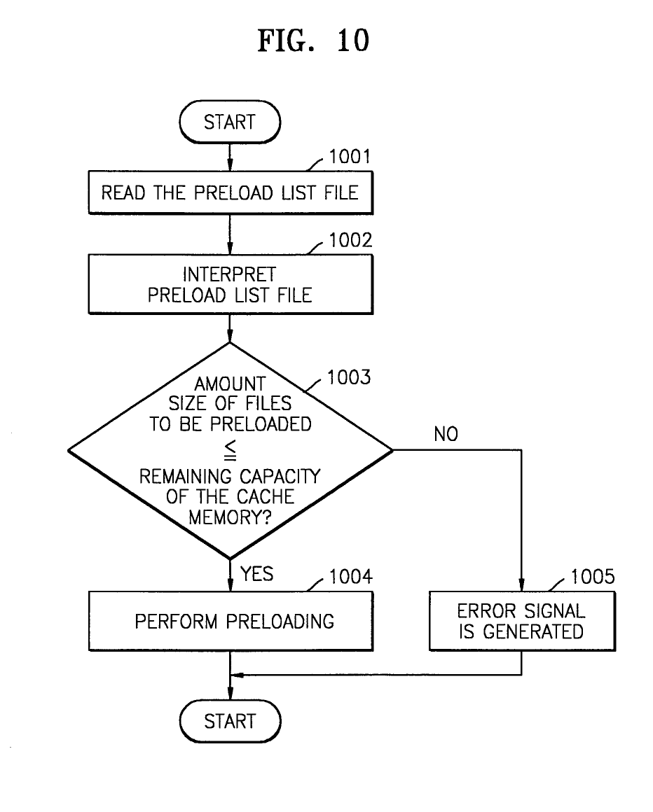

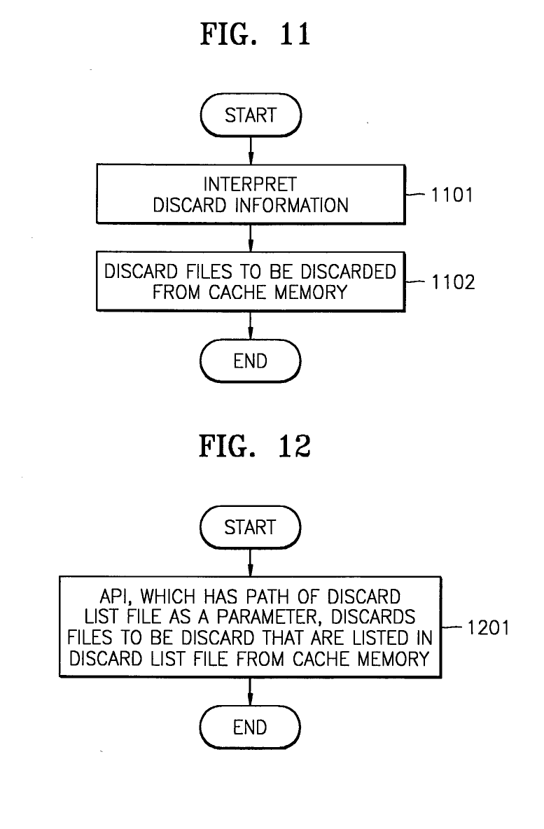

FIG. 9A is another detailed flow chart of operation 603 of FIG. 6. With reference to FIG. 9A, the presentation engine 5 invokes the API, which is inserted into the region bounded by a script tag and has the path of the preload list file as the parameter, and retrieves the preload list file in operation 901a. In operation 901b, the presentation engine 5 interprets the preload list file, including the preload tag having the path and the type of the file to be preloaded as attributes, and performs preloading.

FIG. 9B is yet another detailed flow chart of operation 603 of FIG. 6, where the file to be preloaded is preloaded. With reference to FIG. 9B, the presentation engine 5 invokes the API, which is inserted into the region bounded by the script tag and has the path and the type of the file to be preloaded as parameters, and stores the file to be preloaded in the memory in operation 901b. In this operation, since the presentation engine 5 can identify the type of the file to be preloaded, it can process the file based on the type and store it in the memory.

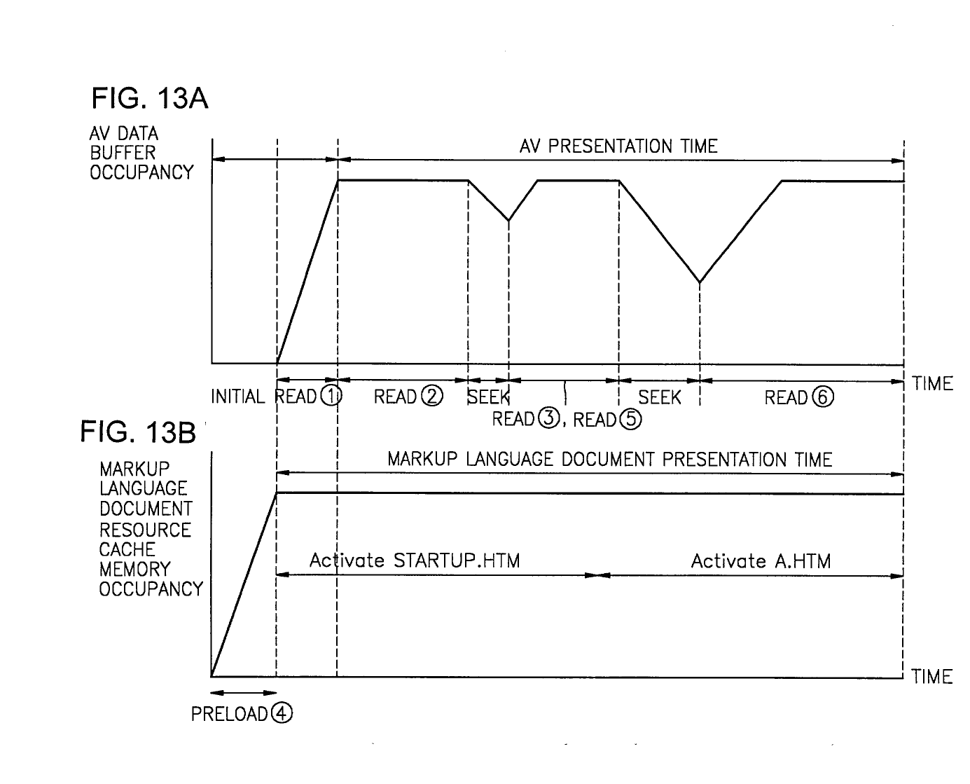

FIG. 10 is a flowchart explaining a method of preloading the files to be preloaded when the preload list file includes the data amount (size) of the files to be preloaded.

With regard to FIG. 10, when the interactive mode is selected, the reader 1 reads the HTML document from the DVD 300. The presentation engine 5 interprets the preload information included in the HTML document, and the reader 1 reads the preload list file in operation 1001. In operation 1002, the presentation engine 5 interprets the preload list file. The presentation engine 5 identifies the amount size of the files to be preloaded and compares the identified size with the remaining capacity of the cache memory in operation 1003. If the data amount of the files to be preloaded is smaller than the remaining capacity of the cache memory, the presentation engine performs the preloading function in operation 1004. If the data amount of the files to be preloaded is bigger than the remaining capacity of the cache memory, the presentation engine 5 generates an error signal and ends the preloading in operation 1005.

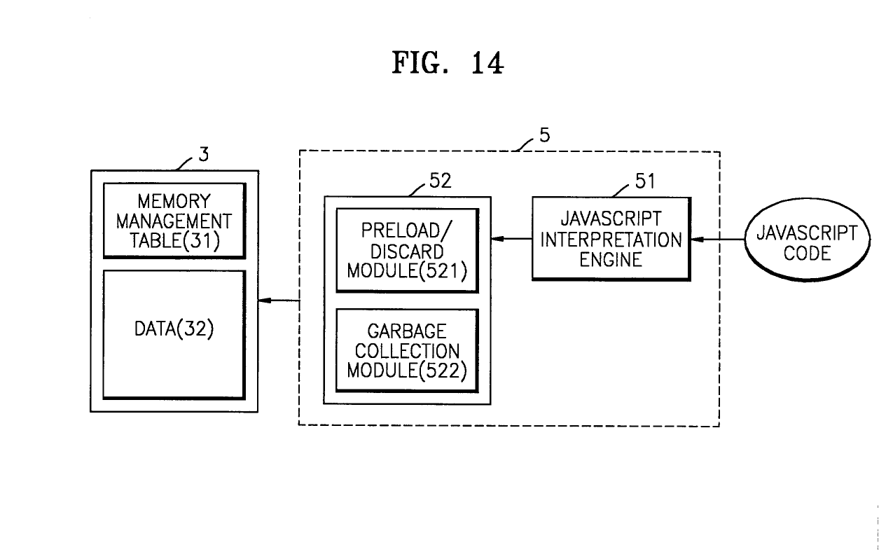

FIG. 11 is a flowchart explaining a method of discarding at least one of the files that are stored in the memory.

With reference to FIG. 11, the presentation engine 5 interprets the discard information included in the HTML document in operation 1101 and discards the files to be discarded that are listed in the discard list file from the second memory 3, which is the cache memory, in operation 1102. As identified by a script program code explained below, the preload list file and the discard list file may be implemented in the same file, that is, STARUP.PLD. The preload list file and the discard list file may also be implemented into two or more separate files.

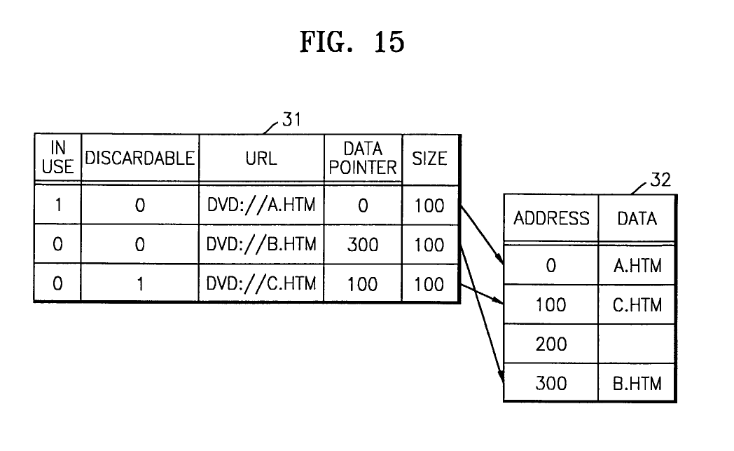

FIG. 12 is a detailed flow chart of operation 1102 of FIG. 11, where the discarding of the file is performed.

With reference to FIG. 12, the API, which has the path of the discard list file as a parameter, discards the files to be discarded that are listed in the discard list file from the second memory 3 which is the cache memory in operation 1201. Here, “discarding” means not performing a garbage collection which discards the data physically, but notifying a status that the data can be discarded by using a flag or that other data can be over recorded while the data physically still remains.

Text data of the above-described file STARTUP.HTM and STARTUP.PLD may be configured as follows.

### EXAMPLE 1 of STARTUP.HTM

<?xml version =“1.0” encoding=“UTF-8”?>
<!DOCTYPE html PUBLIC -//DVD/DTD XHTML DVD-HTML1.0//EN”
“http://www.dvdforum.org/enav/dvdhtml-1-0.dtd”>
<html>
<head>
<title>STARTUP PAGE</title>
<link rel=“preload” src=“dvd://dvd_enav\startup.pld”
OnError=“err_preload()”
OnAbort=“err_preload()”> <!--if preloading is failed, call err_preload -->
<script language=“ecmascript”>
<!--
function html_discard()
{
navigator.Discard(“dvd://dvd_enav\startup.htm”,0);
}
function err_preload()
{
navigator.Discard(“”,2);
if (!navigator.Preload(“dvd://dvd_enav\startup.pld”, 1))
{
alert(“insufficient memory. it will change interactive mode to video mode.”)
DvdVideo.SetVideoMode()
}
}-->
</script>
</head>
<body bgcolor=#ffffff OnUnload=“html_discard()”> <!--if document unload, call html_discard -->
<object height=“50%” width=“60%” data=“dvd:”>
<script language=“ecmascript”>
<!--
DvdVideo.Play() -->
</script></body></html>
<a href=“lid:\\dvd_enav\a.htm”>click to preloaded A.HTM</a>
</body>
</html>

The above text data includes the preload information implemented as the link tag inserted into the region bounded by the head tag. In addition, the discard information implemented as the JavaScript API is inserted.

### EXAMPLE 2 of STARTUP.HTM

<?xml version=“1.0” encoding=“UTF-8”?>
<!DOCTYPE html PUBLIC -//DVD/DTD XHTML DVD-HTML1.0//EN”
“http://www.dvdforum.org/enav/dvdhtml-1-0.dtd”>
<html>
<head>
<title>STARTUP PAGE</title>
<script language=“ecmascript”>
<!--
function html_discard()
{
navigator.Discard(“dvd://dvd_enav\startup.htm”,“text/xml”);
}
function err_preload()
{
navigator.Discard(“ ”,“ ”);
if (!navigator.Preload(“dvd://dvd_enav\startup.pld”,“textlpreload”))
{
alert(“insufficient memory. it will change interactive mode to video mode.”);
DvdVideo.SetVideoMode();
}
}-->
</script>
</head>
<body bgcolor=#ffffff OnUnload=“html_discard()”> <!--if document unload, call html_discard -->
<object height=“50%” width=“60%” data=“dvd:”>
<script language=“ecmascript”>
<!--
if (!navigator.Preload(“dvd://dvd_enav\startup.pld”,“text/preload”))
{
err_preload();
}
DvdVideo.Play();-->
</script></body></html>
<a href=“lid:\\dvd_enav\a.htm”>click to preloaded A.HTM</a>
</body>
</html>

The above text data includes the discard information and the preload information implemented as the JavaScript API.

### EXAMPLE 1 of STARTUP.PLD

<?xml version=“1.0” encoding=“UTF-8”?>
<!DOCTYPE PRELOAD PUBLIC “-\\DVD\\DTD DVD Preload List 1.0\\EN”
“http://www.dvdforum.org/enav/dvd-preload-list.dtd”-->
<preload cachesize=“128KB”>
<filedef type=“text/xml” src=“dvd://dvd_enav//a.htm”/>
<filedef type=“image/png” src=“dvd://dvd_enav//a.png”/>
</preload>

The above text data is the XML document and includes the data amount (size), the paths, and the types of the files to be preloaded.

The API for the preloading/discarding functions used in the above script program code can be explained in detail as follows.

1. Navigator.Preload (URL, flag)

It is the API that reads the specified file to be preloaded to the second memory 3. The used parameters specify the location information of the preload list file or the file to be preloaded.

URL: Path of the preload list file or the path of the file to be preloaded.

flag: When URL indicates the preload list file, flag is 1, and when URL indicates the file to be preloaded, flag is 0.

return value: If the preload performing is successful, “true” is returned. If the preload performing fails, “false” is returned.

For example: navigator.Preload (“http://www.hollywood.com/tom.pld”, 1)

According to this, the preload list file, which has the path of http://www.hollywood.com/tom.pld, is received and read out the files to be listed in the preload list file to the cache memory in advance of reproducing the files.

2. Navigator.Preload (URL, resType)

It is the API that reads the indicated file to be preloaded to the second memory 3. The used parameters specify the location information of the preload list file or the file to be preloaded, and further may indicate the type of the file to be preloaded.

URL: Path of the preload list file or the path of the file to be preloaded.

resType: A type of the file to be preloaded.

return value: If the preload performing is successful, “true” is returned. If the preload performing fails, “false” is returned.

For example: navigator.Preload (“dvd://dvd_enav/a.htm”, “text/xml”)

According to this, the file that is stored in the DVD 300 and has the path of “dvd://dvd_enav/a.htm”, is read to be loaded. The file is a text-based XML file.

navigator.Preload (“http://www.hollywood.com/tom.htm”, “text/html”)

According to this, a file that exists on the Internet server at the locator of http://www.hollywood.com/tom.html is retrieved. The file is a text-based HTML file.

3. Navigator.Discard (URL, flag)

It is the API that discards the indicated file to be discarded from the second memory 3. The used parameters specify the location information of the discard list file or the file to be discarded.

URL: Path of the discard list file or the path of the file to be discarded.

flag: When URL indicates the preload list file, flag is 1, and when URL indicates the file to be preloaded, flag is 0. If flag is 2, it instructs that all contents loaded in the cache memory are discarded from the cache memory.

return value: If the discard performing is successful, “true” is returned. If the discard performing fails, “false” is returned.

For example:

navigator.Discard (‘http://www.hollywood.com/tom.htm’, 0)

If the file to be preloaded after retrieved from the Internet as addressing specified by http://www.hollywood.com/tom.htm, exists in the cache memory, the file is discarded from the cache memory.

4. Navigator.Discard (URL, resType)

It is the API that discards the indicated file to be discarded from the second memory 3. The used parameters specify the location information of the discard list file or the file to be discarded.

URL: Path of the discard list file or the path of the file to be discarded.

resType=A type of the file to be discarded.

return value: If the discard performing is successful, “true” is returned. If the discard performing fails, “false” is returned.

For example:

navigator. Discard (“dvd://dvd_enav/a.htm”, “text/xml”)

According to this, if the file which was read from the DVD 300 as addressing by “dvd://dvd_enav/a.htm”, exists in the cache memory, the file is discarded from the cache memory. The file is a text-based XML file.

navigator.Discard (“dvd://dvd_enav/a.pld”, “application/preload”)

According to this, if the files which are included in the preload list file “dvd://dvd_enav/a.pld”, exist in the cache memory, the files are discarded. The file is the discard list file.

navigator.Discard (“http://www.hollywood.com/tom.htm”,“text/xml”)

According to this, if the file which was retrieved from the Internet as addressing by “http://www.hollywood.com/tom.htm”, exists in the cache memory, the file is discarded from the cache memory. The file is a text-based XML file.

The above-described embodiments explain the API implemented by the JavaScript. The same result can be obtained when the API is implemented by the Java applet.

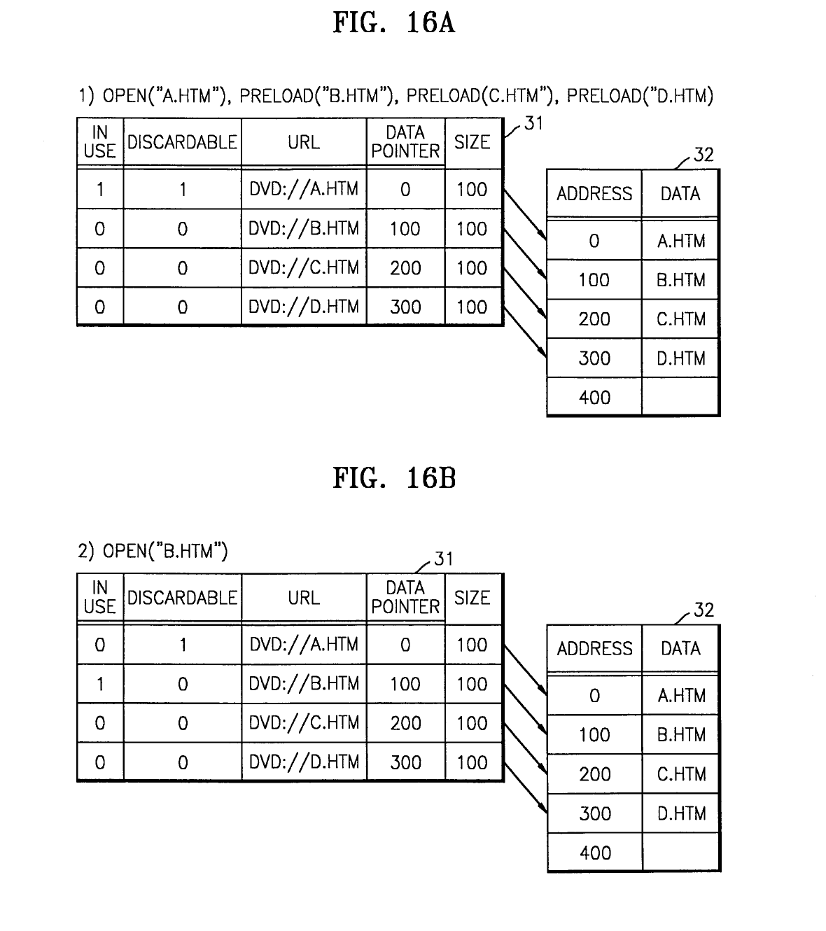

FIGS. 13A and 13B are reference diagrams explaining an effect of the preloading function performed by the reproducing apparatus of FIG. 3.

FIGS. 13A and 13B show a first occupancy of the first memory 2 that buffers the MPEG-coded AV data and a second occupancy of the second memory 3 that caches the markup language documents. With reference to FIGS. 3, 13A and 13B, while the AV data is loaded and displayed, the reader 1 seeks and reads the file STARTUP.htm, and the presentation engine 5 interprets the preload information included in the file STARTUP.HTM and preloads the file A.HTM (4). Then, the file A.HTM (4) is preloaded into the second memory 3. The loaded file STARTUP.HTM becomes activated. Simultaneously, the AV data (1) selected by the presentation sequence is loaded into the first memory 2 and starts to be displayed. Then, the AV data (2) is loaded and displayed. After the AV data (2) is buffered completely, the reader 1 jumps to the position where the AV data (3) is recorded and starts to buffer the AV data (3).

If the user requests the file A.HTM (4), the presentation engine 5 retrieves and displays the file A.HTM (4) preloaded in the second memory 3. That is, the reader 1 does not need to stop buffering the AV data (3) to seek the file A.HTM (4) from the DVD 300 and load it to the second memory 3. Therefore, the reader 1 can perform the buffering seamlessly. When the reader 1 completes the buffering of the AV data (5) and jumps to the AV data (6), the amount of the data buffered in the first memory 2 may be consumed. However, since the amount of the data already buffered is sufficient, buffered data insufficiency does not happen. That is, in case of the DVD which supports the interactive mode, if the DVD video and the markup language document need to be displayed synchronously (for example, when an actor is on stage, his brief history is displayed together with the his moving pictures), the reader 1 does not need to stop buffering the AV data to seek and read the relevant markup language document since the markup language document is already preloaded in the second memory 3.

The next drawings will describe a method of managing the second memory 3 to perform the preloading/discarding functions in a strict manner and the method of performing the preloading function in such a way that the content remaining in the first memory 2 cannot be exhausted.

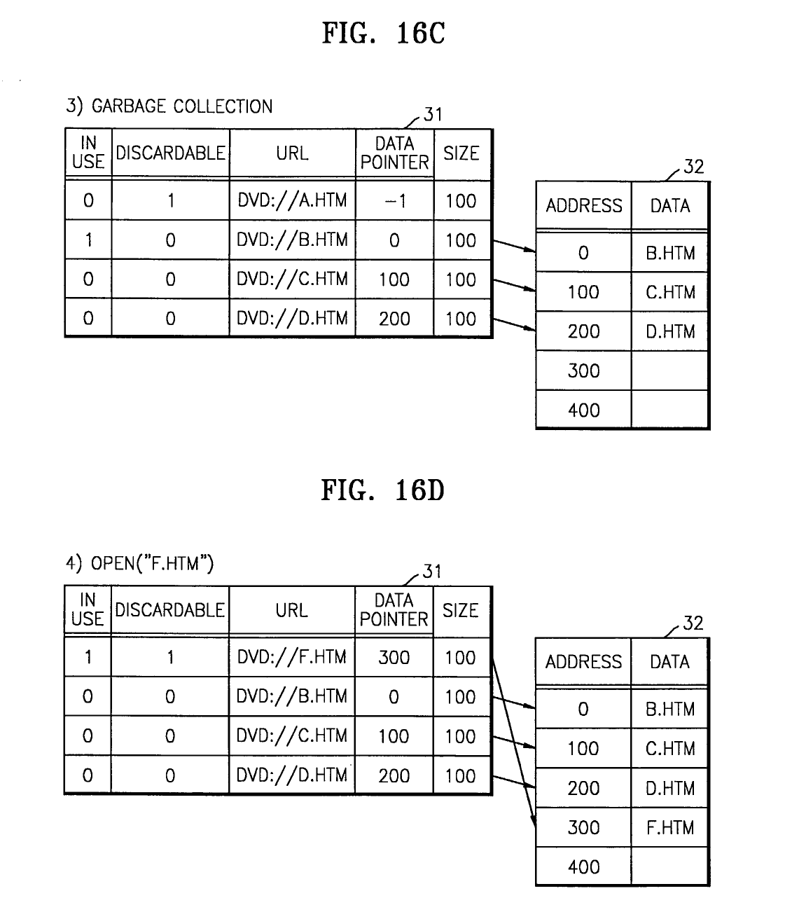

FIG. 14 is a detailed diagram of the reproducing apparatus of FIG. 3.

With reference to FIG. 14, the second memory 3 includes a memory management table 31 and a data section 32. The memory management table 31 has information necessary to manage the data recorded in the data 32. In the data section 32, the markup language document which is preloaded is recorded. The presentation engine 5 includes a JavaScript interpretation engine 51 and an execution module 52. The execution module 52 includes a preloading/discarding module 521 and a garbage collection module 522. The garbage collection module 522 will be explained later.

The JavaScript interpretation engine 51 invokes the API prepared in the JavaScript. The preload/discard module 521 and the garbage collection module 522 perform the preloading/discarding and garbage collection functions, respectively.

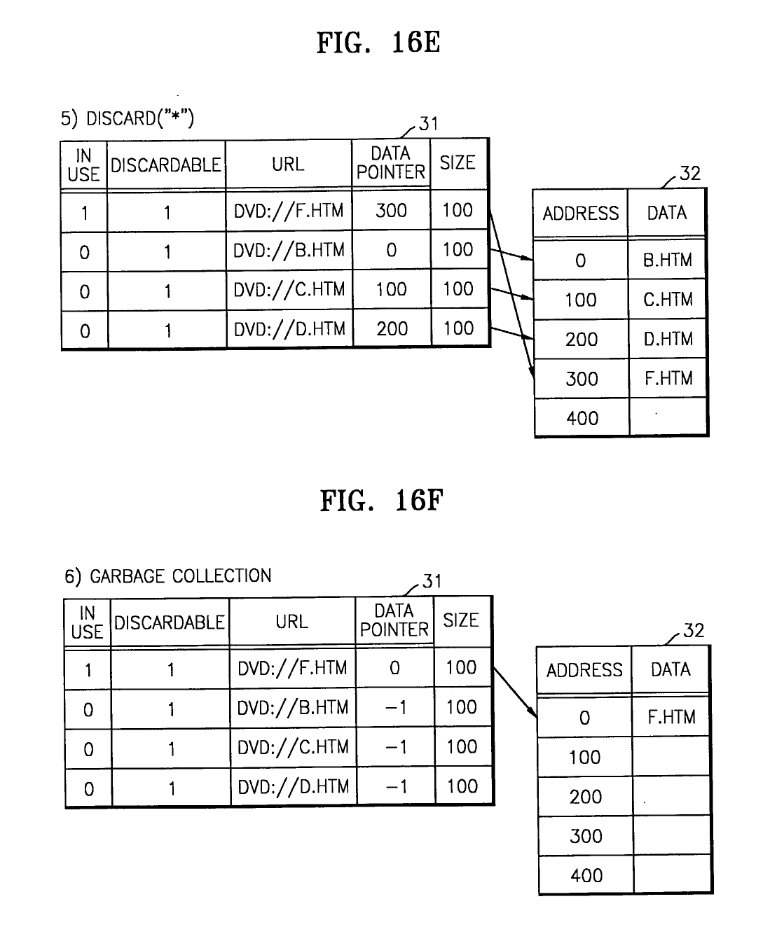

FIGS. 15 and 16A through 16F are memory maps explaining the method of managing the memory management table 31 and the data section 32 by performing the preloading, discarding, and garbage collection functions.

With reference to FIG. 15, the memory management table 31 includes status information of the file to be preloaded, path information about the path of the stored file to be preloaded, pointing information on a data pointer, and the data size. “In use” indicates whether the data is used or not used. “Discardable” indicates whether the data can be discarded or not. “URL” indicates the path information, “data pointer” indicates the starting address of the data in cache memory space, and “size” indicates the data size. Currently, in the data section 32, files A.HTM, C.HTM, and C.HTM are loaded.

With reference to FIG. 16A, the file A.HTM is in use. If the files B.HTM, C.HTM, and D.HTM are preloaded, since the file A.HTM is in use, the “in use” value for the file A.HTM is 1. Because the other files are not open, their “in use” values are 0.

With reference to FIG. 16B, the use of the file A.HTM is completed, and the file B.HTM becomes in use. Therefore, the “in use” values for the files A.HTM and the B.HTM are 0 and 1 respectively.

With reference to FIG. 16C, the garbage collection of the file A.HTM is performed. If the garbage collection function is performed, the file A.HTM is discarded from the data section 32, and the files B.HTM, C.HTM, and D.HTM are realigned for memory compaction. The “data pointer” value of the file a.htm is marked as −1, which means that the relevant file does not exist in the data 32.

With reference to FIG. 16D, the file F.HTM is in use. The file F.HTM is stored in some position the file a.htm shown in FIG. 16C was stored in the memory management table 31. The “data pointer” value indicates the starting address where the file F.HTM is recorded.

With reference to FIG. 16E, the file B.HTM, C.HTM and D.HTM are discarded. Therefore, the “discardable” values for the files B.HTM, C.HTM, and D.HTM are changed to 1.

With reference to FIG. 16F, garbage collection of the file B.HTM, C.HTM, and D.HTM are performed. Therefore, the “data pointer” values for files B.HTM, C.HTM and D.HTM are −1. The files B.HTM, C.HTM and D.HTM that are recorded in the data 32 are discarded and the remaining file F.HTM is realigned.

As above described, the second memory 3 can be managed effectively through the preloading/discarding and garbage collection functions.

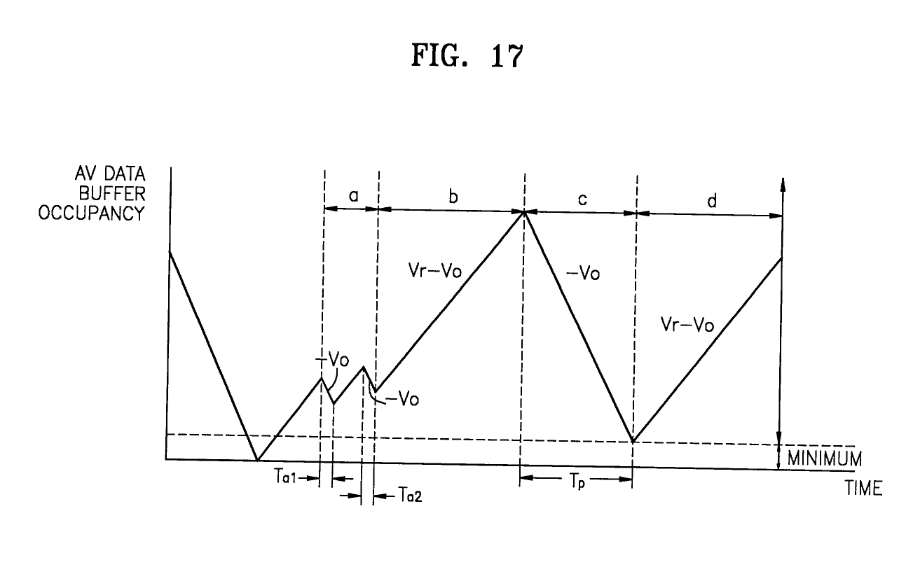

FIG. 17 is a reference diagram showing a case where the AV data is loaded into and exhausted in the first memory 2.

With reference to FIG. 17, for an interval Ta₁ or Ta₂ of a section “a” where a jump to an angle block occurs, the AV data is only consumed without filling the first memory 2. Therefore, the AV data is reduced at a speed of Vo. The angle block includes angle data representing scenes that are shot from different angles. Once the angle data that is shot from an angle is selected, the angle data is reproduced, and the angle data corresponding to other scenes shot from the remaining angles are skipped. As a result, it is inevitable that the jump occurs in the angle block. If the jump is completed and the AV data is read, other data is buffered. As shown in a section “b”, if the AV data is read and consumed at speeds of Vr and Vo, respectively, the AV data is buffered at a speed of Vr-Vo. For a section “c”, if the markup language document is preloaded, the reader 1 stops reading the AV data, and the data is consumed at the speed of Vo since the markup language document is preloaded. For a section “d”, because AV data is buffered again, the AV data is buffered at the speed of Vr-Vo, just as in the section “b”. The horizontal dotted line indicates the minimum amount of AV data that is supposed to be buffered.

For the successful buffering of the first memory 2 and preloading (to prevent data insufficiency in the first memory), a predetermined amount of data remaining in the first memory 2 should be larger than that of the data which is reduced due to the preloading of the file for the section “c”.

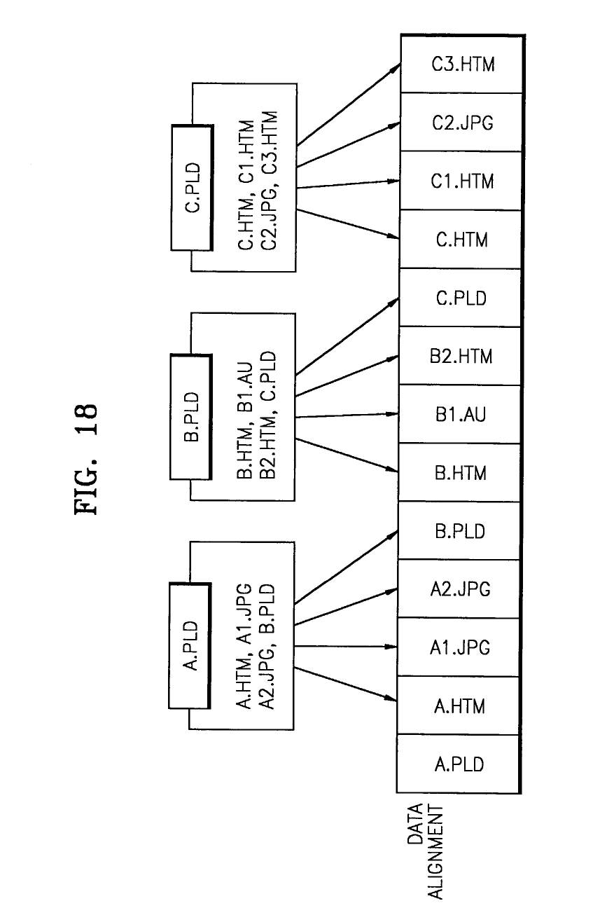

To guarantee a seamless reproduction of the AV data, the reader 1 should read the file to be preloaded as continuously as possible. Therefore, in a file system of a reproducing medium, such as the DVD 300, the data should be aligned in such a way that one PLD file (file to be preloaded) nests other PLD files as shown in FIG. 18 so that the content of the PLD file can be read seamlessly (without interruption of the displaying of the video picture).

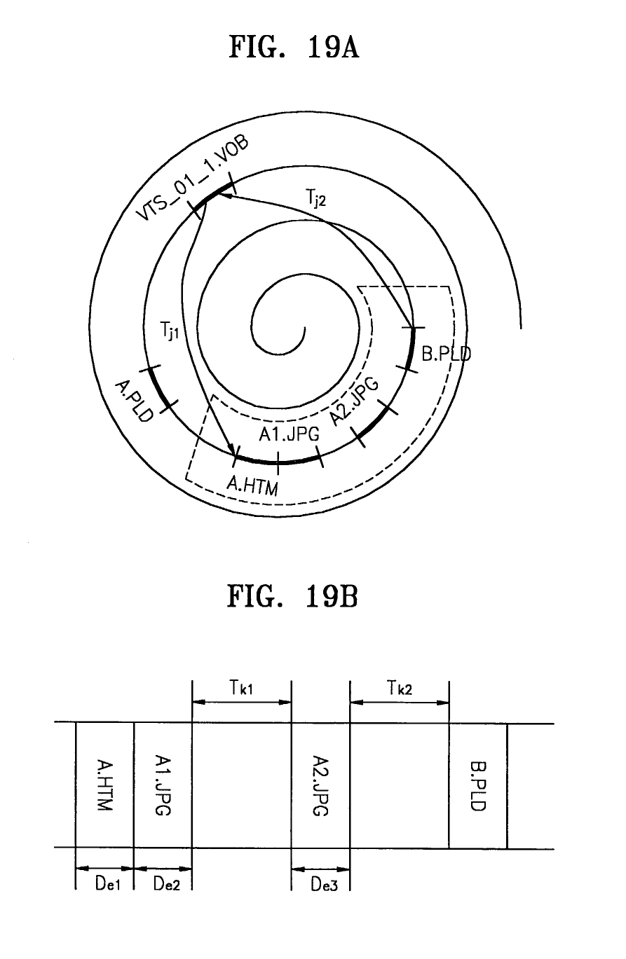

FIG. 19A is an outline diagram of the DVD 300 containing the PLD file of FIG. 18.

With reference to FIGS. 19A and 19B, the reader 1 buffers a video file VTS0_01-1.VOB in the second memory 3, and preloads the files A.HTM, A1.JPG, and A2.JPG listed in the preload list file A.PLD and further preloads the file B.PLD, which is the preload list file, and buffers the video file VTS0_01-1.VOB.

Tj means an access time to the PLD file. That is, in Tj=Tj1+Tj2, Tj1 is the time taken to jump the video file from VTS0_01-1.VOB to the file A1.JPG, and Tj2 is the time taken to jump to the video file VTS0_01-1.VOB again after the file B.PLD is read. De indicates the data size of the PLD file. That is, for De=De1+De2+De3, De1, De2, and De3 indicate the sizes of the files A.HTM, A1.JPG and A2.JPG, respectively. Tk indicates an internal jump time when the PLD file is read. That is, for Tk=Tk1+Tk2, Tk1 indicates the time taken to jump from the file A1.JPG to the file A2.JPG, and Tk2 indicates the time taken to jump from the file A2.JPG to the file B.PLD.

The relationship between the access distance and the access time with regard to the AV data recorded in the disc can be set as follows. Here, N is the number of sectors.

| | | | | | | |
|---|---|---|---|---|---|---|
| Access distance | 0 to 210 | to 5000 | to | to | to | over |
| (sector) | | | 10,000 | 15,000 | 20,000 | 20,000 |
| Access time | 1.45 N | 310 | 360 | 390 | 10 | 1500 |
| (msec) | | | | | | |

According to the embodiment of the present invention, the condition for preventing data insufficiency in the first memory 2 can be indicated as follows.

Vo×Tp<(Vr−Vo)×(tN_ecc×2048×8×16/Vr)−(Vo×Ta)−Bs Formula 1

Vo: The speed at which the AV data is consumed from the first memory 2 or from the AV decoder 4.

Tp: The time taken to perform preloading in the section “c”.

Vr: The speed at which the data is read from the DVD 300.

tN_ecc: The number of ECC blocks that should be read before the PLD file is read.

Ta: The total time taken to perform the jump in the angle block.

Bs: The minimum data size that should be secured in the first memory 2 (Here, a memory has 221 sectors as designated by the DVD-Video Spec. 1.0).

With reference to Formula 1, Vo×Tp indicates the amount of data that is consumed due to the preloading function being performed in the section “c”. tN_ecc×2048×8×16 is a length (the number of sectors) of the data that is read in the section “b”. Vr is the speed at which the data is read. Therefore, tN_ecc×2048×8×16/Vr is the time of the section “b”. That is, (Vr-Vo)×(tN_ecc×2048×8×16/Vr) indicates the amount of data that has increased in the section “b”. Vo×Ta indicates the amount of data that is consumed due to the jump in the angle block in the section “a”. Bs indicates a minimum amount of data that should be buffered. Tp indicates 2×Tj+De/Vr+Tk. The definitions of Tj, De, Vr, and Tk are described above.

Tp, which is the time taken to preload the PLD files designated in files A.PLD, B.PLD, and C.PLD of FIG. 18, can be calculated as follows.

Vr=22 Mbps,

Files (De=1611 KB) in A.PLD: Tp=3600 msec (=1500 msec×2+1611 KB×8/22000000+0)

Files (De=2685 KB) in B.PLD: Tp=4000 msec (=1500 msec×2+2685 KB×8/22000000+0)

Files (De=269 KB) in C.PLD: Tp=3100 msec (=1500 msec×2+269 KB×8/22000000+0)

If the files in A.PLD, B.PLD, and C.PLD should be used in order during the reproduction of the video file VTS_01_1.VOB, the following values should be calculated.

Let the Vo value in the buffering section of the video file VTS_01_1.VOB before the files of A.PLD are read be Va.

Let the Vo value in the buffering section of the video file VTS_01_1.VOB before the files of B.PLD are read be Vb.

Let the Vo value in the buffering section of VTS_01_1.VOB before the files of C.PLD are read be Vc.

On an assumption that there is no jump, such as the jump in the angle block in each section and that Bs has 221 sectors (about 14 ECC blocks), if a relationship between the number of ECC blocks in each section and Va, Vb, and Vc is calculated, the location where the files in A.PLD, B.PLD and C.PLD are read without interruption of the AV data can be found.

For example, on an assumption that Va is 8 Mbps, Vb is 6 Mbps, and Vc is 4 Mbps, tN_ecc can be calculated from Formula 1 as follows.

At least 187 ECC blocks should be read before files in A.PLD are read,

at least 140 ECC blocks should be read before files in B.PLD are read, and

at least 72 ECC blocks should be read before files in C.PLD are read.

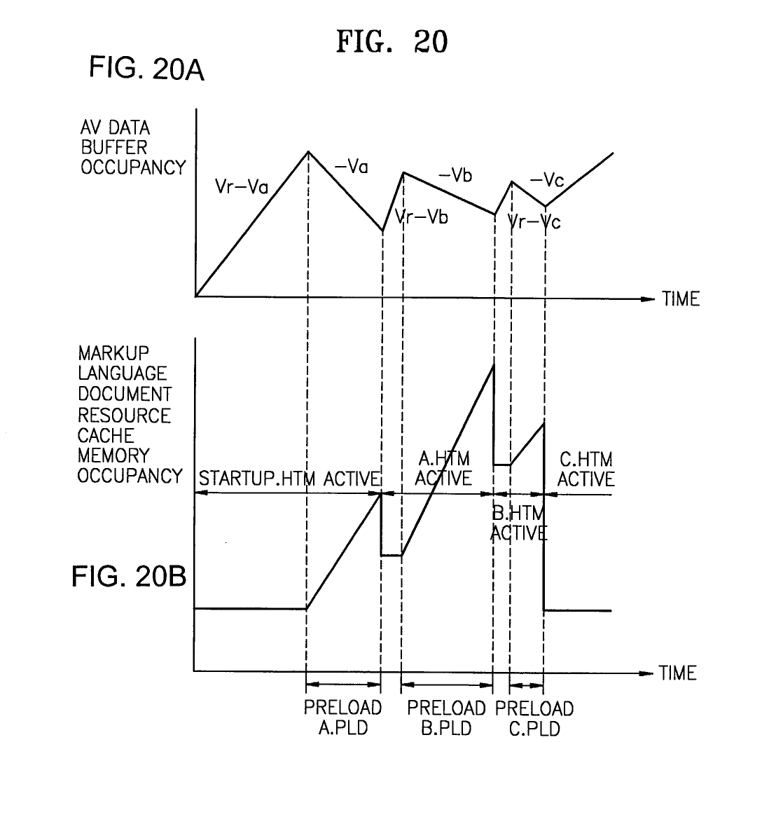

FIGS. 20A and 20B show a status of the first memory 2 and the second memory 3 of FIG. 3.

With reference to FIGS. 20A and 20B, when the file STARTUP.HTM is active, the amount of data in the first memory 2 is increased at the speed of Vr−Va. If the files of A.PLD are preloaded, the amount of data in the first memory 2 is consumed at the speed of Va. If the files of A.PLD are preloaded completely and the file A.HTM is active, the amount of data is buffered increasingly at the speed of Vr−Vb. If the files of B.PLD are preloaded, the amount of data in the first memory 2 is consumed at the speed of Vb. If the files of B.PLD are preloaded completely and the file B.HTM is activated, the amount of the data is buffered increasingly at the speed of Vr−Vc. Here, the amount of the data is reduced drastically at the point where the preloading of the second memory 3 is completed because the PLD file is requested to be discarded and garbage collection is performed.

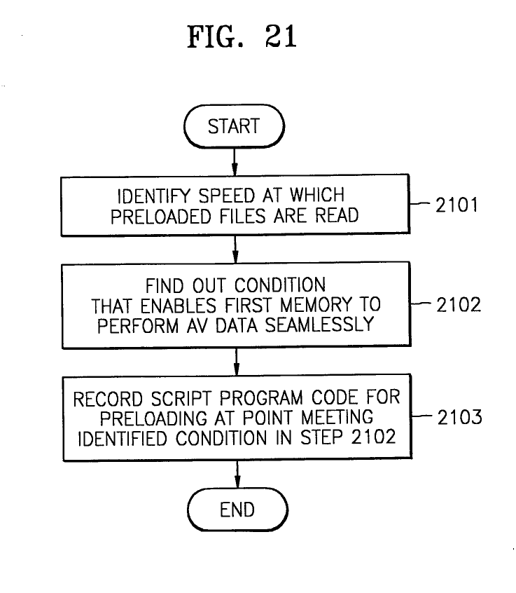

FIG. 21 is a flowchart showing a recording method according to another embodiment of the present invention.

With reference to FIG. 21, a content creator identifies the speed at which the PLD file is read in operation 2101. In operation 2102, the content creator finds out the condition that enables the first memory 2 to perform relevant AV data seamlessly. The condition is described in detail above. The content creator records the script program code for preloading at the point meeting the identified condition in operation 2103. That is, a relevant API is invoked to record the script program code in such a way that the AV data is preloaded seamlessly after minimum AV data is buffered in the first memory 2.

As described above, in a case where the AV data recorded in the information storage medium such as DVD is reproduced and displayed through the markup language document, the present invention relates to the information storage medium that includes the markup language document and prevents the interruption of reproducing the video pictures, and a reproducing apparatus and a reproducing method. In addition, since the present invention can identify the type of the files to be preloaded and discarded, more effective preloading and discarding of the files can be performed.

Although a few preferred embodiments of the present invention have been shown and described, it would be appreciated by those skilled in the art that changes may be made in this embodiment without departing from the principles and sprit of the invention, the scope of which is defined in the claims and their equivalents.

What is claimed is:

1. An information storage medium read and executed by a reproducing apparatus having a memory, comprising:
audio/video (AV) data representing a video picture; and
markup language document data including preload information that allows the reproducing apparatus to read a preload file relating to a content of a markup language document to be preloaded in response to the preload information, to store the preload file into the memory, and to display the video picture of the AV data in the markup language document corresponding to the file.

2. The medium of claim 1, further comprising:
navigation data contained in the AV data, wherein the AV data is decoded in an AV data stream with reference to the navigation data.

3. The medium of claim 2, wherein the preload file comprises a plurality of files, and the reproducing apparatus is allowed to preload at least one of the files from the information storage medium.

4. The medium of claim 1, wherein the markup language document data comprises a preload list file which includes the preload file to be preloaded, and the preload information is implemented by a link tag where location information of the preload list file is recorded.

5. The medium of claim 4, wherein the link tag is inserted into a head area bounded by a head tag.

6. The medium of claim 5, wherein the reproducing apparatus is connected to an Internet server, and the location information comprises a path of the preload list file and a resource locator, which indicates one of the memory, the information storage medium, and the Internet server.

7. The medium of claim 1, wherein the markup language document data comprises a preload list file which includes the preload file to be preloaded, and the preload information is implemented by an Application Program Interface (API) which has location information of the preload list file as a parameter.

8. The medium of claim 7, wherein the API is a JavaScript API or a Java applet API.

9. The medium of claim 8, wherein the reproducing apparatus is connected to an Internet server, and the location information comprises a path of the preload list file and a resource locator, which indicates one of the memory, the information storage medium, and the Internet server, which is linked to the path of the preload list file.

10. The medium of claim 1, wherein the markup language document data comprises a preload list file which includes the preload file to be preloaded, and the preload list file comprises the location information and the property of the preload file to be preloaded.

11. The medium of claim 10, wherein the preload list file further comprises information on an data amount of the memory necessary to store the preload file to be preloaded.

12. An information storage medium read and executed by a reproducing apparatus having a memory, comprising:
AV data representing a video picture; and
a markup language document data including preload information that allows the reproducing apparatus to read a preload file relating to a content of a markup language document to be preloaded in response to the preload information, to store the preload file into the memory, and to display the video picture of the AV data which is decoded and reproduced in an AV data stream, in the markup language document corresponding to the file.

13. The medium of claim 12, further comprising:
navigation data on the AV data, wherein the AV data is decoded in an AV data stream with reference to the navigation data.

14. The medium of claim 13, wherein the preload file comprises a plurality of files, and at least one of the files is preloaded.

15. The medium of claim 14, wherein the markup language document data comprises a preload list file including the file to be preloaded, and the preload information is implemented by an API which has location information of the preload list file as a parameter.

16. The medium of claim 15, wherein the reproducing apparatus is connected to an Internet server, and the location information comprises a path of the preload list file and a resource locator, which indicates one of the memory, the information storage medium, and the Internet server, which is connected to the path of the preload list file.

17. The medium of claim 15, wherein the preload information is implemented by an API which has the location information and a property of the file to be preloaded as parameters.

18. The medium of claim 12, wherein the markup language document data comprises:
a discard list file which contains a discard list; and
discard information contained in the discard list and indicating that the preload file to be discarded that is recorded in the discard list should be discarded from the memory.

19. The medium of claim 18, wherein the discard information is implemented by an Application Program Interface (API) which has location information of the discard list file as a parameter.

20. The medium of claim 12, wherein the markup language document further comprises:
discard information indicating that the preload file to be discarded in the discard list should be discarded from the memory.

21. The medium of claim 20, wherein the discard information comprises an Application Program Interface (API) which has location information of the discard list file as a parameter.

22. A method of reproducing AV data recorded in an information storage medium by invoking the AV data through a markup language document, the method comprising:
interpreting preload information included in the read markup language document;
invoking a preload file relating to a content of the markup language document to be preloaded based on the preload information and storing the preload file to a first memory;
reading the AV data and storing it in a second memory; and
reading the AV data and the preload file to be preloaded from the second memory and the first memory, respectively, and displaying them based on the markup language document.

23. The method of claim 22, wherein the interpreting of the preload information comprises:
identifying a path and a property of the preload file to be preloaded.

24. The method of claim 23, wherein the identifying of the path and the property of the preload file comprises identifying the path of a preload list file that is recorded in a link tag inserted in a head region bounded by head tags.

25. The method of claim 24, wherein the invoking of the preload file comprises:
reading the preload file to be preloaded from the identified path; and
processing and storing the preload file to be preloaded depending on the identified property.

26. The method of claim 22, further comprising:
interpreting and executing an application Program Interface (API), which is inserted into a body region bounded by a body tag, has a path of a preload list file as a parameter, and invokes the preload file to be preloaded in the preload list file.

27. The method of claim 22, wherein the invoking of the preload file comprises:
invoking the preload file to be preloaded from the information storage medium.

28. The method of claim 22, wherein the reproducing apparatus is connected to an Internet server, and the invoking of the preload file comprises:
invoking the preload file to be preloaded from the Internet server.

29. An apparatus for reproducing AV data recorded in an information storage medium with a markup language document, the apparatus comprising:
a reader reading the markup language document or the AV data;
a memory storing a preload file relating a content of the markup language document to be preloaded or the AV data;
an AV decoder decoding the AV data stored in the memory; and
a presentation engine controlling the reader to read the preload file and the memory to store the preload file to be preloaded based on the preload information after interpreting the preload information included in the read markup language document, controlling the memory to store the read AV data, and reading the preload file to be preloaded from the memory and displaying the preload file together with the AV data outputted by the AV decoder.

30. The apparatus of claim 29, wherein the memory comprises:
a buffer memory storing the AV data; and
a cache memory storing the preload file to be preloaded.

31. The apparatus of claim 30, wherein the presentation engine identifies a path and a property of the preload file to be preloaded based on the preload information, invokes the preload file to be preloaded from the identified path, and stores the preload file according to the property in the cache memory.

32. The apparatus of claim 31, wherein the reproducing apparatus is connected to an Internet server, and the presentation engine controls the reader to read the preload file or the Internet server to send the preload file to be preloaded to the reproducing apparatus.

33. The apparatus of claim 32, wherein the preload information comprises a resource locator indicating one of the memory, the information storage medium, and the Internet server, which is linked to the path of the preload list file, and the presentation engine requests the cache memory to send the preload file to be preloaded if the resource locator linked to the path of a preload list file indicates the cache memory, or generates an error event if there is no preload file to be preloaded in the cache memory.

34. The apparatus of claim 30, wherein the preload information further includes the information on a data size of the preload file to be preloaded, and the presentation engine compares an amount of a data space remaining in the cache memory with the size of the preload file to be preloaded and generates an error event if the amount of the data space remaining in the cache memory is less than the data size of the preload file to be preloaded.

35. The apparatus of claim 30, wherein the markup language document comprises location information of a discard list file containing the preload file to be discarded and discard information indicating that the preload file to be discarded should be discarded from the cache memory, and the presentation engine interprets the discard information and location information and controls the cache memory to discard the preload file to be discarded.

36. A method of reproducing AV data and markup language document data in a reproducing apparatus having a memory, the method comprising:
reading preloading information from the markup language document data;
preloading a preload file relating to a content of the markup language document in response to the preloading information;
identifying a speed at which the preload file to be preloaded is read;
identifying a condition of the memory performing buffering in such a way that the AV data is reproduced seamlessly; and
(c) performing a preloading in response to the identified condition.

37. A method of storing AV data during reproducing an information storage medium, comprising:
recording a preload file relating to a content of a markup language document to be preloaded;
identifying a speed at which the recorded preload file to be preloaded is read;
identifying a condition of buffering of the AV data in such a way that the AV data can be reproduced seamlessly; and
recording source codes to perform a preloading function to preload the preload file in response to the identified condition.

38. A method of managing a memory of a reproducing apparatus, the method comprising:
recording a memory management table containing status information of a preload file relating to a content of a markup language document to be preloaded; and
discarding the preload file to be preloaded from the memory based on the status information.

39. The method of claim 38, further comprising:
performing a garbage collection on the preload file to be preloaded based on the status information.

40. The method of claim 39, wherein the discarding of the preload file comprises:
indicating the status information as a discard status when the preload file to be preloaded is is preloaded.

41. The method of claim 39, wherein the performing of the garbage collection comprises:
discarding the preload file to be preloaded physically if used; and
indicating the status information that the preload file to be preloaded is discarded and no longer exists as the status information.

42. The method of claim 41, wherein the preload file comprises a plurality of files, and the performing of the garbage collection further comprises:
realigning the files recorded in the memory to be preloaded.

43. A method in a reproducing apparatus having a memory and reproducing an interactive medium having AV data and markup language document data, the method comprising:
reading the markup language document data having preload information from the interactive medium to generate a markup language document;
reading and storing the AV data in the memory;
determining a data amount of the AV data stored in the memory; and
preloading a preload file relating to a content of the markup language document in response to the preload information and the data amount.

44. The method of claim 43, further comprising:
generating a seamless video picture corresponding to the AV data stored in the memory without interruption.

45. The method of claim 44, wherein the preloading of the preload file comprises:
preventing the data amount of the AV data stored in the memory from being lowered from a reference value by preloading the preload file.

46. The method of claim 43, wherein the preloading of the preload file comprises:
storing the preload file in the memory in response to the preload information and the data amount.

47. The method of claim 43, wherein the apparatus is connected to an external source, and the preloading of the preload file comprises receiving the preload file from one of the interactive medium and the external source.

48. The method of claim 47, wherein the external source is an Internet server.

49. The method of claim 43, wherein the preloading of the preload file comprises:
preloading a second preload file relating to a second content of the markup language document; and
discarding the preload file from the memory.

50. The method of claim 49, wherein the preload file is discarded when the preload is read from the memory and used in the markup language document.

51. The method of claim 48, wherein the preload file is discarded in response to the data amount of the memory.

52. A reproducing apparatus having a memory and reproducing an interactive medium having AV data and markup language document data, comprising:
a reader reading the AV data and the markup language document data having preload information from the interactive medium to generate a markup language document;
a memory storing the AV data; and
a presentation engine determining a data amount of the AV data stored in the memory and preloading a preload file relating to a content of the markup language document in response to the preload information and the data amount.

53. The reproducing apparatus of claim 52, wherein the presentation engine generates a seamless video signal corresponding to the AV data read from the memory in the markup language document without an interruption during receiving the content of the markup language document.

54. The reproducing apparatus of claim 53, wherein the presentation engine preloads the preload file before the data amount of the AV data is less than a reference value.

55. The reproducing apparatus of claim 53, wherein the presentation engine stores the preloading information having one of a path and a location of the preload file.
